(19) United States
(12) Patent Application Publication
(10) Pub. No.: US 2012/0101830 A1
(43) Pub. Date: Apr. 26, 2012

(54) JEWELRY SYSTEM AND METHOD FOR SELLING A PIECE OF JEWELRY BY INCLUDING A STORY OF THE PIECE

(76) Inventor: Hasmukh Dholakiya, North Bergen, NJ (US)

(21) Appl. No.: 12/910,200

(22) Filed: Oct. 22, 2010

(51) Int. Cl. G06Q 30/00; G06F 15/16; G09F 3/00; A44C 17/02; A44C 5/00

(52) U.S. Cl. 705/1.1; 63/26; 63/3; 40/299.01; 709/229

(57) ABSTRACT

A jewelry system and a method for selling jewelry. The jewelry system includes a piece of jewelry that is associated with an information booklet providing a story of formation of the piece and a website for registration of the piece. The initial story that is included in the information booklet includes history of formation of a gemstone used in the piece and the process of manufacture of the setting that lead to the finished product. The website permits the owners to add their personal story to the initial story of the piece. The method for selling the jewelry provides the jewelry, the information booklet and the website address to the buyer. Information regarding the piece is maintained at a server that is linked to the website and may be made available to future second-hand buyers of the piece and to family and friends of the owner.

### BACKGROUND OF THE INVENTION

1—Field of the Invention

The present invention relates generally to jewelry and selling of jewelry and, more particularly, to selling pieces of jewelry that include gemstones.

2—Description of Related Art

Gemstones, such as diamonds, rubies, emeralds, sapphires, turquoises, semi-precious stones and the like, may each come from various mines or sources and may each be subjected to various processes before they reach the body of the person owning them and wearing them.

Conventionally, a piece of jewelry including a gemstone is sold to a customer based on the specifications of the jewelry and particularly the specifications of the gemstone. More recently, because of the heightened social awareness regarding the ills associated with the so-called “blood diamonds,” some merchants advertise their diamonds as “conflict-free diamonds” in order to put the customer's conscience at ease. Generally, aside from these limited types of information, no other history or story is provided to customer.

### SUMMARY OF THE INVENTION

Aspects of the present invention provide systems and methods for selling jewelry pieces that include gemstones. The systems and methods of the aspects of the present invention, improve upon the experience of buying and owning a piece of jewelry by including the true source of the gemstone that is set in the piece of jewelry and the story behind the formation of the gemstone and the manufacture of the piece. The systems and methods of the present invention may further provide registration for the piece. The registration serves to authenticate the piece.

Systems and methods of the present invention, thus, help increase both monetary value and sentimental value of a piece of jewelry by providing credible information to the buyer regarding the sources of the material and the labor that have contributed to the finished product and by allowing the buyer to include his or her personal story that led to the purchase of the piece. This information may be preserved in a database that is made available to potential second hand and third hand buyers of the piece.

Aspects of the present invention provide a jewelry system including a piece of jewelry, and an information tag associated with the piece of jewelry. The piece of jewelry includes a setting and a gemstone. The information tag has a unique one to one correlation with the piece of jewelry that is established by an identification code. The information tag includes a history of formation and processing of the gemstone, a history of design and fabrication of the setting, and a history of manufacture of the piece of jewelry.

In various aspects of the present invention, the piece of jewelry may be selected from a group consisting of a ring, a necklace, a choker, a pendant, a bracelet, an anklet, and a tiara. The ring includes a finger ring and rings used in pierced body parts. The information tag may be physically associated with the piece of jewelry. The identification code may be selected from a number, a name, an alphanumeric string, a bar code and a radio frequency identification code. The gemstone may be selected from a group consisting of one or more diamonds, rubies, emeralds, sapphires, turquoises, and semi-precious stones.

In various aspects of the present invention the jewelry system may further include a website having an address included on the information tag, and a server serving the website and including storage media for storing information entered at the website. The website permits registration of the piece of jewelry at the website, and additional information regarding the piece of jewelry entered to the website is stored at the server and remains associated with the piece of jewelry. The registration of the piece of jewelry and the additional information regarding the piece of jewelry may be made available to a seller and a buyer of the piece of jewelry and to third parties referring to the website. The third parties may include heirs of the buyer who inherit the piece of jewelry and future buyers who buy from the buyer. The identification code may be placed on some of the parts forming the piece of jewelry including the setting and the gemstone and the registration of the piece of jewelry at the website certifies authenticity of the parts that include the identification code. More than one piece or one type of gemstone may be used in the piece.

Aspects of the present invention provide a method of selling jewelry where the jewelry includes a setting and a gemstone. The method includes providing the jewelry to a customer together with an information tag associated with the jewelry, the information tag reciting a story of the jewelry, the story including origins of and processes performed on the gemstone and the setting leading to manufacture of the jewelry as presented to the customer, and providing a website to the customer for registration of the jewelry, the website permitting the customer to enter personal information regarding purchase and use of the jewelry in order to personalize the story. The jewelry and the information tag are associated and have a one to one relationship, the information tag uniquely identifying the jewelry.

In various aspects of the present invention, the method may further include one or more of manufacturing the information tag to recite the story, manufacturing the jewelry, establishing the website and storing the story on a storage medium in communication with the website, associating the information tag with the jewelry via an identification code included on the information tag and on the jewelry, providing access to the story on the website for family and friends of the customer and future buyers of the jewelry from the customer, and certifying authenticity of the jewelry on the website for future buyers of the jewelry from the customer. The access to the story for the family, the friends and the future buyers may be provided via the identification code. In one aspect, the access to the story for the family, the friends and the future buyers may be provided via information regarding the gemstone, the setting or a current owner of the jewelry.

In one aspect of the present invention, successive owners of the jewelry are identified on the website and stories of successive owners of the jewelry is provided on the website.

Aspects of the present invention further provide a method of personalized registration of jewelry pieces that includes establishing a website for the registration, providing a server accessible from the website where the server is used for storing information associated with the jewelry pieces, providing access to a purchaser of a piece of jewelry to register the piece at the website, providing permission to the purchaser to add a personal story regarding the piece to the website, providing access to the information associated with the piece to a first group of visitors to the website, and providing access to the personal story to a second group of visitors to the website. The first group includes potential second-hand buyers of the piece, the second group includes friends and family of the purchaser, and the first group and the second group may overlap.

The booklet and the registration website together serve as a birth certificate plus a passport for the piece of jewelry. They show where the jewelry came from and where has it been since it was born. Moreover, if the owners care to enter their stories at the website, pictures and stories of the various journeys that the jewelry has taken, for example the various owners it has had and why they purchased it and what their lives were about, are added to the birth certificate and the passport.

### BRIEF DESCRIPTION OF THE DRAWINGS

FIG. 1 shows a jewelry system including a piece of jewelry and an associated information booklet, according to aspects of the present invention.

FIG. 2 shows a registration system, according to aspects of the present invention, associated with the jewelry system of FIG. 1.

FIG. 3 shows a flowchart of a method of selling jewelry, according to aspects of the present invention.

FIG. 4 shows a front cover view of a jewelry information booklet, according to aspects of the present invention.

FIG. 5 shows a back cover view of the jewelry information booklet of FIG. 4, according to aspects of the present invention.

FIG. 6 shows an insert view of the jewelry information booklet of FIG. 4, according to aspects of the present invention.

FIG. 7 shows a front view of a counter stand booklet, according to aspects of the present invention.

### DETAILED DESCRIPTION OF THE INVENTION

Aspects of the present invention provide systems and methods for selling jewelry. The jewelry that is sold according to the aspects of the present invention includes one or more gemstones placed in a setting. The jewelry may be a necklace, a bracelet, an anklet, a ring or another type of jewelry. The gemstones may include diamonds, rubies, sapphires, emeralds, turquoises or other types of precious or semi-precious stones.

The systems and methods of the aspects of the present invention, improve upon the experience of buying and owning a piece of jewelry by including the true source of the gemstone that is set in the piece of jewelry, the story behind the formation of the gemstone, the story behind the manufacture of the setting that holds the gemstone, and the story of the fabrication of the overall piece in general.

Systems and methods of the present invention, thus, help increase the monetary value of a piece of jewelry by providing credible information to the owner regarding the sources of the material and the labor that have contributed to the finished product. The sentimental value of the piece is also increased when the source and origin of the piece is identified to be conflict free. The sentimental value may be further increased by adding the personal story of the purchaser to the information that is associated with the piece.

The systems and methods of the present invention further provide registration for the piece. Registration would preserve the information regarding the piece in a database that may be made available to potential second hand and third hand buyers of the piece. Registration permits the buyers to include their personal story at a registration website. The personal story provides context to friends and family of the owner if the piece is a symbolic piece of jewelry such as a wedding ring or an anniversary gift. The personal story also remains associated with the jewelry for future generations that may inherit the jewelry. Registration further serves to authenticate the piece for future buyers if a current buyer decides to sell the jewelry at a later point in time.

For the remainder of the specification, the aspects of the present invention are described in the context of a diamond ring as one example of a jewelry piece that is used in embodiments of the present invention.

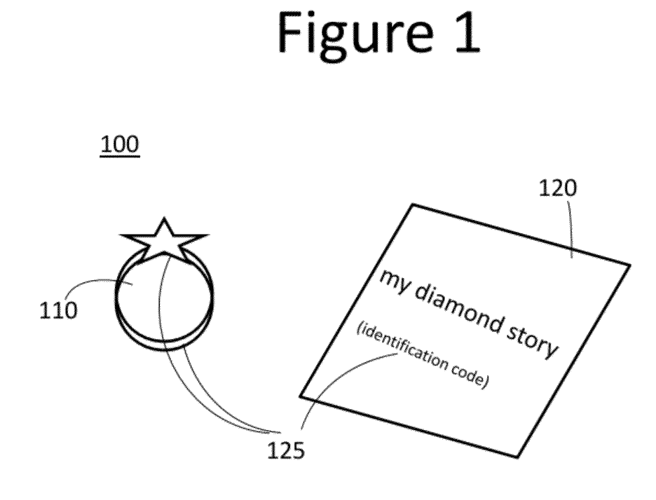

FIG. 1 shows a jewelry system including a piece of jewelry and an associated information booklet, according to aspects of the present invention.

FIG. 1 shows system 100 that includes a diamond ring 110 and an information booklet 120 associated with the ring. The diamond ring is packaged and sold with the information booklet.

The ring 110 is exemplary and other pieces of jewelry which include precious stones may equally serve as a part of the jewelry system 100.

The information booklet 120 may be a pamphlet or a brochure made from paper, plastic, leather, glass, metal or another material capable of being written upon. The information booklet may also be an electronic book or made from electronic paper.

In the system 100, the ring 110 and the information booklet are associated with an identification code 125 that establishes a unique one to one correlation between the two. Thus, the information booklet of one ring is not replaceable with the information booklet of another ring.

The identification code may be an RFID code, a bar code, a number, an alphanumeric string such as a name or some other similar means capable of uniquely identifying an object. The identification code may be placed on just the setting that houses the gemstones or it may be placed on all various parts of the piece of jewelry. If the identification code is later used as a means for certifying the authenticity of the piece of jewelry, all or some of the various parts of the piece may be required to include the code. A piece of jewelry that includes several gemstones on a setting may derive its value from one or more of the gemstones or from the finished product that combines all of the gemstones in a particular arrangement within the setting. In one aspect of the present invention, the parts of the jewelry that contribute the most to its value are marked by the code. In another aspect, and depending on the number and size of the parts, all of the parts may be marked by the code.

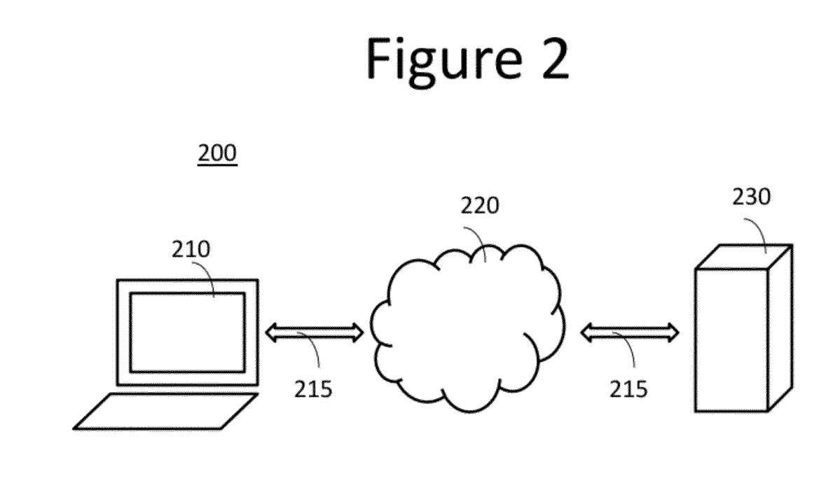

FIG. 2 shows a registration system, according to aspects of the present invention, associated with the jewelry system of FIG. 1.

FIG. 2 shows the registration system 200 including a registration station 210 and a registration server 230 that are coupled together via the internet 220. Communications 215 between the registration station 210 and the registration server 230 with the internet 220 may be wired or wireless. Moreover, the registration station 210 and the registration server 230 may be directly connected without an intermediary. The registration station 210 may be a station set up at the jewelry store or a personal computer of the buyer. The registration server may be rented or owned and is controlled by a central management.

For example, a buyer of the jewelry system 100 of FIG. 1 uses the information available in the information booklet 120 to register his ring 110 at the registration server 230 by accessing the registration website from his personal computer which operates as the registration station 210.

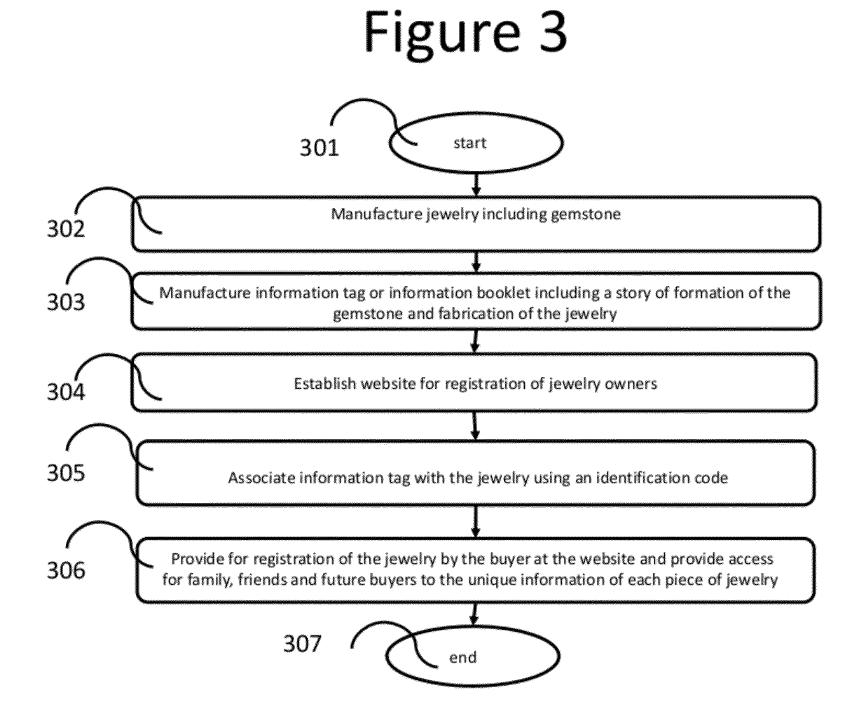

FIG. 3 shows a flowchart of a method of selling jewelry, according to aspects of the present invention.

At 301, the method begins. At 302, the jewelry is manufactured. The jewelry includes a setting and one or more gemstones.

At 303, an information booklet or information tag is prepared that includes the specific information of the jewelry manufactured at 302. In one aspect of the present invention, the entity who prepares the information tag obtains the material that is included in the information tag from the manufacturer of the jewelry. If the information in the tag is to be used for registration and authentication of the jewelry that is associated with the tag, then the entity who prepares the tag has to assure itself that the information provided by the manufacturer is true and correct.

At 304, a website is established for registration of the jewelry owners. The website leads to storage media for storing the information provided in each information tag.

At 305, the information tag is associated with the piece of jewelry to which it pertains. The information tag is either physically attached to the piece of jewelry or a unique identification code associates the two in a one to one correlation. Using a unique identification code prevents the loss of the one to one relationship when the ring is separated from the tag or booklet in order to be worn.

At 306, the website or the registration station provides for registration of the information available in the information tag at the storage media of the registration station. The website also allows access by potential second-hand buyers, friends and family and future generations who may inherit the jewelry. Access for third party onlookers such as second hand buyers, friends and family may be set up such that it requires permission by the owner. Access may be set up such that it is public and searchable by various parameters including the specifications of the jewel, name of the manufacturer or the name of the owner. Registration at the website may serve as authentication for the jewelry such that the information pertaining to a specific identification may provide certification of authenticity for the identified jewelry. At 307, the method ends.

When different entities perform the various steps of the above method, they each provide assurances for the following entity that the information is true and accurate.

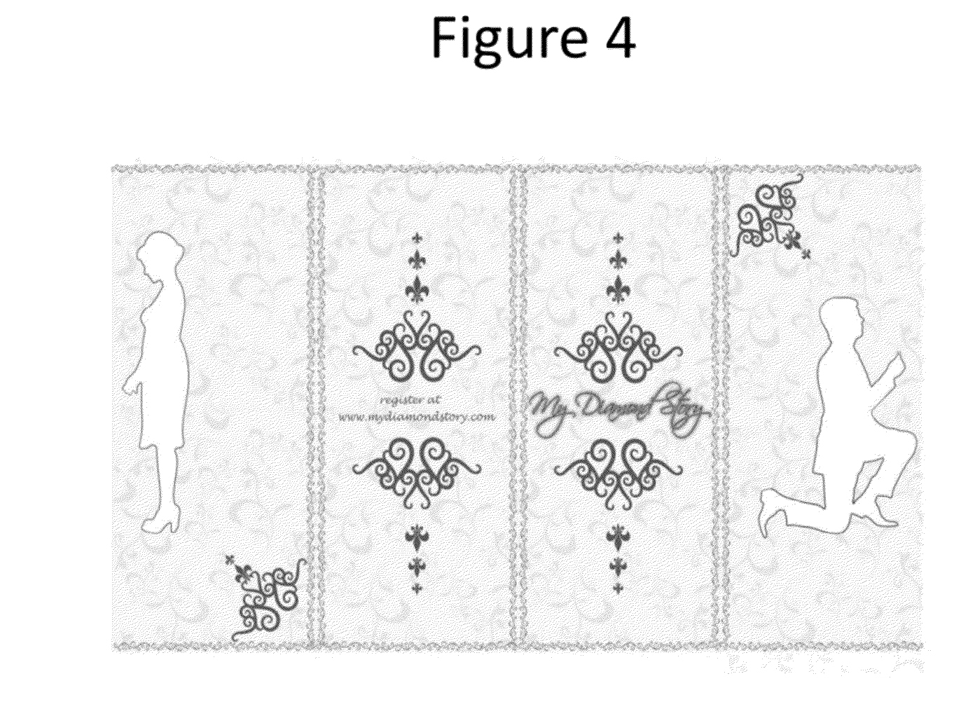

FIG. 4 shows a front cover view of a jewelry information booklet, according to aspects of the present invention.

In FIG. 4 an exemplary information tag or information booklet associated with a diamond ring is depicted. The booklet has the caption “My Diamond Story” and informs the owner that he may register at www.mydiamondstory.com.

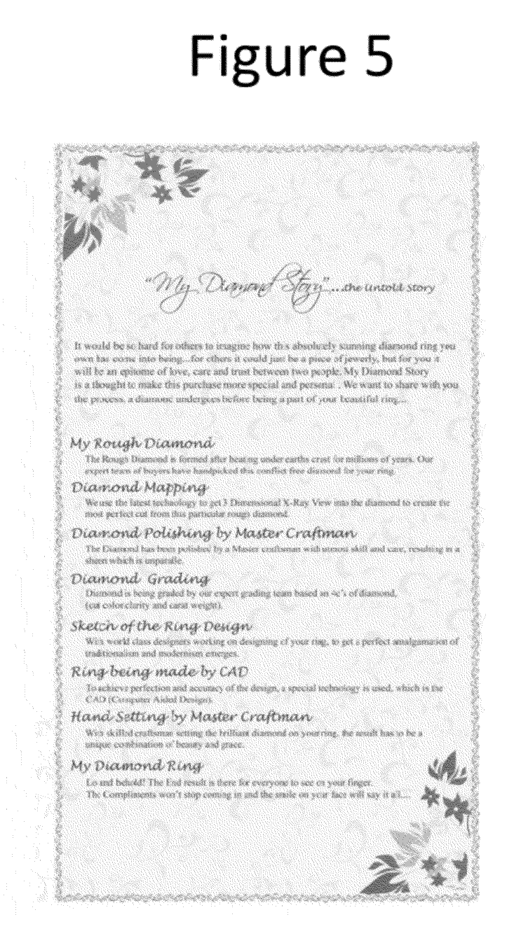

FIG. 5 shows a back cover view of the jewelry information booklet of FIG. 4, according to aspects of the present invention.

FIG. 5 shows the back cover of an exemplary information tag or booklet such as the exemplary booklet shown in FIG. 4. The back cover explains how including the booklet with the ring makes the purchase more personal. The booklet explains the story and a history of the diamond from the mine to the ring of the person wearing the ring. The exemplary booklet shown, lists the headings: My Diamond, Diamond Mapping, Diamond Polishing by Master Craftsmen, Diamond Grading, Sketch of the Ring Design, Ring Being Made By CAD, Handsetting by Master Craftsmen, and finally My Diamond Ring. The headings and the contents are changed to match the gemstone and the piece of jewelry if other than a diamond and a ring. Under the heading “My Diamond,” the booklet explains that the diamond is formed under the heat and pressure of the earth's crust and after millions of years. Under this heading, it is also specified that the particular diamond is conflict free. Under the heading “Diamond Mapping,” the type of technology for evaluating the diamond to determine a suitable cut for it is specified. For example, 3D X-ray technology may be used to look through the diamond and find the cut that suits the particular diamond. Under the heading “Diamond Polishing by Master Craftsmen,” it is explained that a craftsman has to polish the diamond to achieve a perfect sheen. Under the heading “Diamond Grading,” it is explained that the particular diamond is graded by the craftsmen based on cut, color, clarity, and carat weight which make up the 4 Cs of diamond. Under the heading “Sketch of the Ring Design,” it is explained that the design of the setting or ring is by master designers. Under the heading “Ring Being Made By CAD,” it is explained that the setting or the ring is actually made by computer aided design machinery using CAD-CAM technology. Under the heading “Handsetting by Master Craftsmen,” it is explained that craftsmen have to set the diamond on the ring. Finally, under the heading “My Diamond Ring,” it is declared that after the placing of the gemstone into the setting, the ring is complete.

The diamond story shown in FIG. 5 may include more or less detail depending on context.

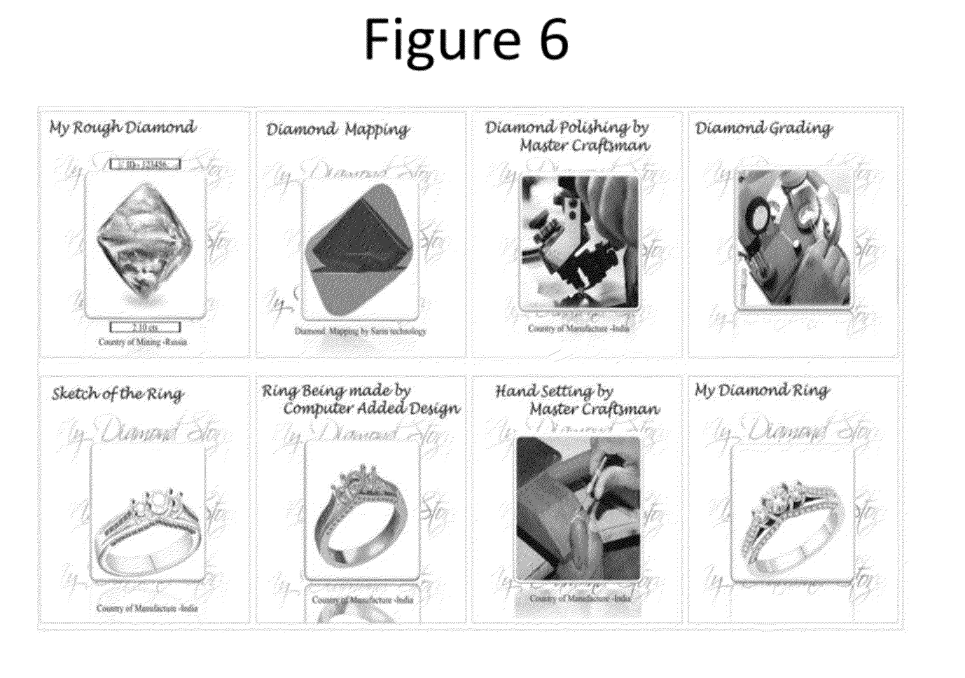

FIG. 6 shows an insert view of the jewelry information booklet of FIG. 4, according to aspects of the present invention.

FIG. 6 includes pictorial depictions of the stages or headings that are shown in FIG. 5. In FIG. 6, the weight of the diamond in carats and its particular identification code or identification number are shown. FIG. 6 includes particulars regarding each of the steps of making the ring such as the origin of the diamond, the country of design and manufacture of the setting and the finished product as well as the particular technology used for each of the steps such as mapping, polishing, and grading.

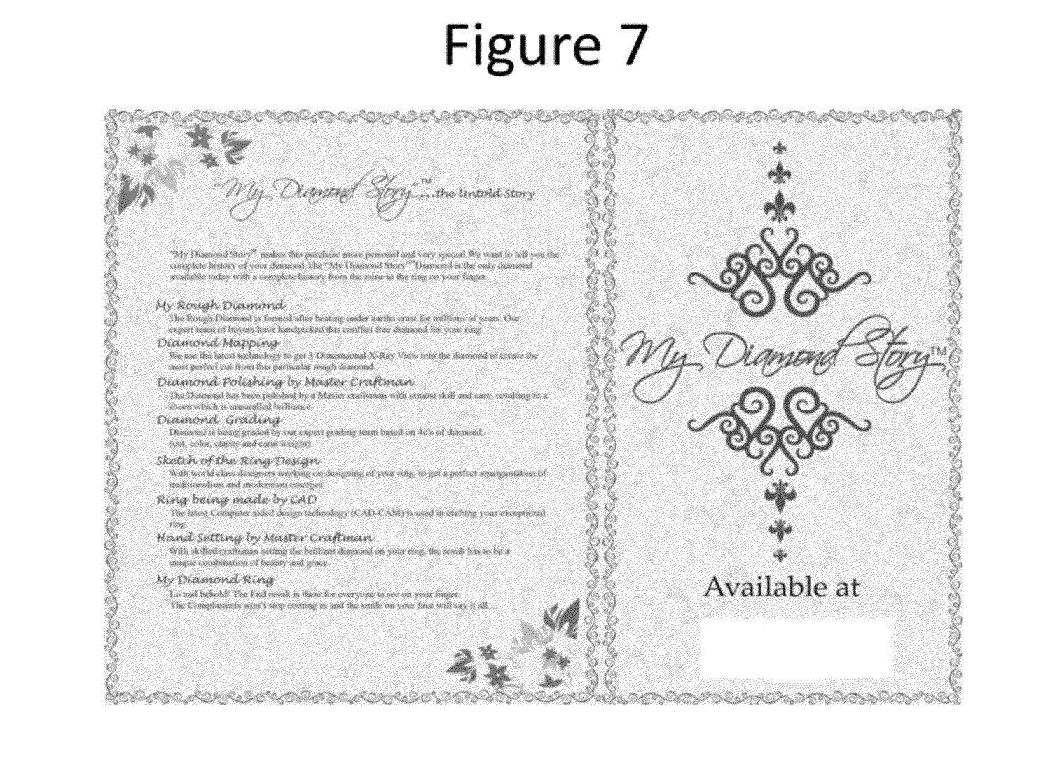

FIG. 7 shows a front view of a counter stand booklet, according to aspects of the present invention.

The counter stand booklet shown in FIG. 7 repeats the information on the back of the information booklet as shown in FIG. 5. The counter stand information is general and may only include the headings and information that is common to all products sold in association with the information booklet. Each particular ring has its own particular identification and information that may be included only in the particular information tag or booklet that is associated with the ring.

Thus, a combination of the information booklet and the additional material that is entered into the registration website provide a birth certificate and a passport for the piece, showing how and where it was born and where has it traveled since being born. Each step in the method and system may be implemented by a computer, microprocessor, or a network of computers, and information (including the information tag) may be stored on a database, a network of computers and/or any other computer readable storage medium.

The present invention has been described in relation to particular examples, which are intended to be illustrative rather than restrictive, with the scope and spirit of the invention being indicated by the following claims and their equivalents.

1. A jewelry system comprising:
a piece of jewelry; and
an information tag associated with the piece of jewelry,
wherein the piece of jewelry includes a setting and a gemstone,
wherein the information tag has a unique one to one correlation with the piece of jewelry, the correlation being established by an identification code,
wherein the information tag includes a history of formation and processing of the gemstone, a history of design and fabrication of the setting, and a history of manufacture of the piece of jewelry.

2. The jewelry system of claim 1,
wherein the piece of jewelry is selected from a group consisting of a ring, a necklace, a choker, a pendant, a bracelet, an anklet, and a tiara,
wherein the ring includes a finger ring and rings used in pierced body parts.

3. The jewelry system of claim 1,
wherein the information tag is physically associated with the piece of jewelry.

4. The jewelry system of claim 1,
wherein the identification code is selected from a number, a name, an alphanumeric string, a bar code and a radio frequency identification code.

5. The jewelry system of claim 1,
wherein the gemstone is selected from a group consisting of one or more diamonds, rubies, emeralds, sapphires, turquoises, and semi-precious stones.

6. The jewelry system of claim 1, further comprising:
a website having an address included on the information tag; and
a server serving the website and including storage media for storing information entered at the website,
wherein the website permits registration of the piece of jewelry at the website, and
wherein additional information regarding the piece of jewelry entered to the website is stored at the server and remains associated with the piece of jewelry.

7. The jewelry system of claim 6,
wherein the registration of the piece of jewelry and the additional information regarding the piece of jewelry are made available to a seller and a buyer of the piece of jewelry and to third parties referring to the website.

8. The jewelry system of claim 7,
wherein the third parties include heirs of the buyer who inherit the piece of jewelry and future buyers who buy from the buyer.

9. The jewelry system of claim 6,
wherein the identification code is placed on a first number of parts forming the piece of jewelry including the setting and the gemstone, the gemstone including one or more gemstones of a same type or of various types, and
wherein the registration of the piece of jewelry at the website certifies authenticity of the parts that include the identification code.

10. A method of selling jewelry, the jewelry including a setting and a gemstone, the method comprising:
providing the jewelry to a customer together with an information tag associated with the jewelry, the information tag reciting a story of the jewelry, the story including origins of and processes performed on the gemstone and the setting leading to manufacture of the jewelry as presented to the customer; and
providing a website to the customer for registration of the jewelry, the website permitting the customer to enter personal information regarding purchase and use of the jewelry in order to personalize the story,
wherein the jewelry and the information tag are associated and have a one to one relationship, the information tag uniquely identifying the jewelry.

11. The method of claim 10, further comprising:
manufacturing the information tag to recite the story.

12. The method of claim 11, further comprising:
manufacturing the jewelry.

13. The method of claim 1, further comprising:
establishing the website and storing the story on a storage medium in communication with the website.

14. The method of claim 10, further comprising:
associating the information tag with the jewelry via an identification code included on the information tag and on the jewelry,
wherein the identification code is selected from a number, a name, an alphanumeric string, a bar code and a radio frequency identification code.

15. The method of claim 10, further comprising:
providing access to the story on the website for family and friends of the customer and future buyers of the jewelry from the customer.

16. The method of claim 10, further comprising:
certifying authenticity of the jewelry on the website for future buyers of the jewelry from the customer.

17. The method of claim 15,
wherein the access to the story for the family, the friends and the future buyers is provided via the identification code.

18. The method of claim 15,
wherein the access to the story for the family, the friends and the future buyers is provided via information regarding the gemstone, the setting or a current owner of the jewelry.

19. The method of claim 10,
wherein successive owners of the jewelry are identified on the website, and
wherein stories of successive owners of the jewelry is provided on the website.

20. A method of personalized registration of jewelry pieces, the method comprising:
establishing a website for the registration;
providing a server accessible from the website, the server for storing information associated with the jewelry pieces;
providing access to a purchaser of a piece of jewelry to register the piece at the website;
providing permission to the purchaser to add a personal story regarding the piece to the website;
providing access to the information associated with the piece to a first group of visitors to the website; and
providing access to the personal story to a second group of visitors to the website,
wherein the first group includes potential second-hand buyers of the piece,
wherein the second group includes friends and family of the purchaser, and
wherein the first group and the second group are capable of overlapping.
